(19) United States
(12) Patent Application Publication
(10) Pub. No.: US 2026/0136288 A1
(43) Pub. Date: May 14, 2026

(54) UE ADDRESSING WITH WUS CODES

(71) Applicant: Telefonaktiebolaget LM Ericsson (publ), Stockholm (SE)

(72) Inventors: Luca Feltrin, Solna (SE); Yanpeng Yang, Järfälla (SE); Andreas Höglund, Solna (SE); Mohammad Mozaffari, Fremont, CA (US)

(21) Appl. No.: 19/119,177

(22) PCT Filed: Nov. 1, 2023
(86) PCT No.: PCT/SE2023/051096

§ 371 Date: Apr. 8, 2025

Related U.S. Application Data
(60) Provisional application No. 63/423,392, filed on Nov. 7, 2022.

(51) Int. Cl. H04W 52/02

(52) U.S. Cl. CPC H04W 52/0235

(57) ABSTRACT

Systems and methods are disclosed that relate to User Equipment (UE) addressing with Wake-Up Signal (WUS) codes. In one embodiment, a method performed by a UE comprises monitoring a WUS occasion for two or more WUSs that correspond to two or more codes, respectively, that together represent a Wake-Up Group Identifier (WUGI) assigned to the UE. The method further comprises performing one or more actions based on a result of the monitoring. In this manner, UE or UE group addressing is provided for WUS. Corresponding embodiments of a network node and a method of operation thereof are also disclosed.

### RELATED APPLICATIONS

This application claims the benefit of provisional patent application Ser. No. 63/423,392, filed Nov. 7, 2022, the disclosure of which is hereby incorporated herein by reference in its entirety.

### TECHNICAL FIELD

The present disclosure relates to a wireless communication system and, more specifically, to the use of a Wake-Up Signal (WUS) in a wireless communication system.

### BACKGROUND

In 3^{rd} Generation Partnership Project (3GPP) wireless communication systems, Wake-Up Receiver (WUR), sometimes also referred to as ‘wake-up radio’, is about enabling a low power receiver in User Equipments (UEs), which, in case of the detection of a Wake-Up Signal (WUS), wakes up the main (baseband/higher power) receiver to detect an incoming message, typically paging (e.g. Physical Downlink Control Channel (PDCCH) in Paging Occasions (POs), scheduling the paging message on Physical Downlink Shared Channel (PDSCH)). The main benefit of employing WUR is lowering energy consumption and longer device battery life, or at a fixed energy consumption the downlink latency can be reduced due to shorter Discontinuous Reception (DRX)/duty-cycles and more frequent checks for incoming transmissions.

FIG. 1 is an illustration of the location of a WUS and the paging occasion to which it is associated.

### WUS for NB-IoT and LTE-M

In 3GPP Release 15, WUS was specified for Narrowband Internet of Things (NB-IoT) and Long Term Evolution (LTE) for Machine Type Communication (MTC) (LTE-M). The main motivation was UE energy consumption reduction since, with coverage enhancement, PDCCH could be repeated many times, and the WUS is relatively much shorter and hence requires less reception time for the UE. The logic is that a UE would check for a WUS a certain time before its PO and, only if a WUS is detected, the UE would continue to check for PDCCH in the PO. If a WUS is not detected, which is most of the time, the UE can go back to a sleep state to conserve energy. Due to coverage enhancements, the WUS can be of variable length depending on the UE's coverage, see FIG. 2.

A WUS is based on the transmission of a short signal that indicates to the UE that it should continue to decode the downlink (DL) control channel, e.g., full Narrowband PDCCH (NPDCCH) for NB-IoT. If such signal is absent (DTX, i.e., UE does not detect it), then the UE can go back to sleep without decoding the DL control channel. The decoding time for a WUS is considerably shorter than that of the full NPDCCH since it essentially only needs to contain one bit of information whereas the NPDCCH may contain up to 35 bits of information. This, in turn, reduces UE power consumption and leads to longer UE battery life. The WUS would be transmitted only when there is a paging for the UE. But if there is no paging for the UE, then the WUS will not be transmitted (i.e., implying a discontinuous transmission, DTX), and the UE would go back to deep sleep, e.g., upon detecting DTX instead of WUS. This is illustrated in FIG. 1, where white blocks indicate possible WUS and PO positions whereas the black boxes indicate actual WUS and PO positions.

The specification of Rel-15 WUS is spread out over several parts of the LTE 36-series standard, e.g., 3GPP Technical Specifications (TSs) 36.211, 36.213, 36.304 and 36.331.

A UE will report its WUS capability to the network, as well as its WUS gap capability (see below). Further WUS information was added to the paging message/request from the Mobility Management Entity (MME) to evolved or enhanced Node B (eNB) (see UE radio paging capabilities). The eNB will use WUS for paging the UE if: (1) WUS is enabled in the cell (i.e., WUS-Config present in System Information (SI)) and (2) the UE supports WUS according to the wake UpSignal-r15 UE capability (see also the description of WUS gap below).

WUS was introduced for both LTE-M and NB-IoT with support for both DRX and enhanced DRX (eDRX). For DRX, WUS was introduced with a 1-to-1 mapping between the WUS and the PO. For eDRX, WUS was defined with the possible configuration of 1-to-N (many) POs. The eNB can configure one WUS gap for UEs using DRX and another WUS gap for UEs using eDRX [see the following excerpt from 3GPP TS 36.331 where emphasis is added via bold, italicized text, examples are given for NB-IoT, LTE-M is similar]:

```
      ***** START EXCERPT FROM 3GPP TS 36.331 *****
          WUS-Config-NB information element
```

| | |
|---|---|
| WUS-Config-NB-r15 ::= | SEQUENCE { |
| maxDurationFactor-r15 | WUS-MaxDurationFactor-NB-r15, |
| numPOs-r15 | ENUMERATED {n1, n2, n4} |

DEFAULT n1,

| | |
|---|---|
| numDRX-CyclesRelaxed-r15 | ENUMERATED {n1, n2, n4, n8}, |
| timeOffsetDRX-r15 | ENUMERATED {ms40, ms80, ms160, |

ms240},

| | |
|---|---|
| timeOffset-eDRX-Short-r15 | ENUMERATED {ms40, ms80, ms160, |

```
ms240},
    timeOffset-eDRX-Long-r15 ENUMERATED {ms1000, ms2000}
    OPTIONAL, -- Need OP
    ...
}
```

| | |
|---|---|
| WUS-ConfigPerCarrier-NB-r15 ::= | SEQUENCE { |
| maxDurationFactor-r15 | WUS-MaxDurationFactor-NB-r15 |

}

| | |
|---|---|
| WUS-MaxDurationFactor-NB-r15 ::= | ENUMERATED {one128th, |

```
one64th, one32th, one16th, oneEighth, oneQuarter, oneHalf}
        WUS-Config-NB field descriptions
  timeOffsetDRX
  When DRX is used, non-zero gap from the end of the configured maximum
  WUS duration to the associated PO, see TS 36.304 [4], clause 7.4 and TS
  36.211 [21]. In milliseconds. Value ms40 corresponds to 40ms, value ms80
  corresponds to 80 ms and so on.
  timeOffset-eDRX-Short
  When eDRX is used, the short non-zero gap from the end of the configured
  maximum WUS duration to the associated PO, see TS 36.304 [4], clause 7.4
  and TS 36.211 [21]. In milliseconds. Value ms40 corresponds to 40ms, value
  ms80 corresponds to 80 ms and so on.
  E-UTRAN configures timeOffset-eDRX-Short to a value longer than or equal to
  timeOffsetDRX.
  timeOffset-eDRX-Long
  When eDRX is used, the long non-zero gap from the end of the configured
  maximum WUS duration to the associated PO, see TS 36.304 [4], clause 7.4
  and TS 36.211 [21]. In milliseconds. Value ms1000 corresponds to 1000 ms,
  value ms2000 corresponds to 2000 ms.
        ***** END EXCERPT FROM 3GPP TS 36.331 *****
```

The UE capabilities can also indicate the minimum WUS gaps required for the UE to be able to decode PDCCH in the associated PO, for DRX and eDRX, respectively, as shown in the following excerpt from 3GPP TS 36.331 where emphasis is added via bold, italicized text:

```
      ***** START EXCERPT FROM 3GPP TS 36.331 *****
        UE-RadioPagingInfo-NB information element
```

| | |
|---|---|
| UE-RadioPagingInfo-NB-r13 ::= | SEQUENCE { |
| ue-Category-NB-r13 | ENUMERATED {nb1} |

```
  OPTIONAL,
  ...,
```

| | |
|---|---|
| [[ multiCarrierPaging-r14 | ENUMERATED {true} |

```
        OPTIONAL
  ]],
```

| | |
|---|---|
| [[ mixedOperationMode-r15 | ENUMERATED {supported} |

OPTIONAL,

| | |
|---|---|
| wakeUpSignal-r15 | ENUMERATED {true} |

OPTIONAL,

| | |
|---|---|
| wakeUpSignalMinGap-eDRX-r15 | ENUMERATED {ms40, |

ms240, ms1000, ms2000} OPTIONAL,

| | |
|---|---|
| multiCarrierPagingTDD-r15 | ENUMERATED {true} |

```
        OPTIONAL
  ]],
```

| | |
|---|---|
| [[ ue-Category-NB-r16 | ENUMERATED {nb2} |

OPTIONAL,

| | |
|---|---|
| groupWakeUpSignal-r16 | ENUMERATED {true} |

OPTIONAL,

| | |
|---|---|
| groupWakeUpSignalAlternation-r16 | ENUMERATED {true} |

```
    OPTIONAL
  ]]
}
wakeUpSignalMinGap-eDRX
Indicates the minimum gap the UE supports between WUS or GWUS and associated
PO in case of eDRX in FDD, as specified in TS 36.304 [4]. Value ms40 corresponds to
40 ms, value ms240 corresponds to 240 ms and so on. If this field is included, the UE
shall also indicate support for WUS or GWUS for paging in DRX.
        ***** END EXCERPT FROM 3GPP TS 36.331 *****
```

At the end of Rel-15, a longer WUS gap of 1 second(s) or 2 s was introduced to enable the use of WUR. That is, starting up the main baseband receiver if a WUR is used for the detection of WUS may take a longer amount of time. If this is supported in the cell, the eNB would include timeOffset-eDRX-Long in the WUS-Config in System Information (SI) (see above). In 3GPP TS 36.304, the UE behavior for monitoring paging with WUS is specified, and in Table 7.4-1 it is indicated which WUS time gap the UE (and eNB) should apply depending on the reported UE capability, as shown in the following excerpt from 3GPP TS 36.304:

| | ***** START EXCERPT FROM 3GPP TS 36.304 ***** |
|---|---|
| 7.4 | Paging with Wake Up Signal |

Paging with Wake Up Signal is only used in the cell in which the UE most recently
entered RRC_IDLE triggered by:

| | |
|---|---|
| - | reception of RRCEarlyDataComplete; or |
| - | reception of RRCConnectionRelease not including noLastCellUpdate; or |
| - | reception of RRCConnectionRelease including noLastCellUpdate and the UE was |
| | using (G)WUS in this cell prior to this RRC connection attempt. |

If the UE is in RRC_IDLE, the UE is not using GWUS according to clause 7.5 and the
UE supports WUS and WUS configuration is provided in system information, the UE
shall monitor WUS using the WUS parameters provided in System Information. When
DRX is used and the UE detects WUS the UE shall monitor the following PO. When
extended DRX is used and the UE detects WUS the UE shall monitor the following
numPOs POs or until a paging message including the UE's NAS identity is received,
whichever is earlier. If the UE does not detect WUS the UE is not required to monitor the
following PO(s). If the UE missed a WUS occasion (e.g. due to cell reselection), it
monitors every PO until the start of next WUS or until the PTW ends, whichever is
earlier.

| | |
|---|---|
| - | numPOs = Number of consecutive Paging Occasions (PO) mapped to one WUS |
| | provided in system information where (numPOs≥1). |

The WUS configuration, provided in system information, includes time-offset between
end of WUS and start of the first PO of the numPOs POs UE is required to monitor. The
timeoffset in subframes, used to calculate the start of a subframe g0 (see TS 36.213
[6]), is defined as follows:

| | |
|---|---|
| - | for UE using DRX, it is the signalled timeoffsetDRX; |
| - | for UE using eDRX, it is the signalled timeoffset-eDRX-Short if timeoffset-eDRX- |
| | Long is not broadcasted; |
| - | for UE using eDRX, it is the value determined according to Table 7.4-1 if |
| | timeoffset-eDRX-Long is broadcasted |

Table 7.4-1: Determination of GAP between end of WUS and associated PO

| | | timeoffset-eDRX-Long | |
|---|---|---|---|
| | | 1000 ms | 2000 ms |
| UE Reported | 40 ms or | timeoffset-eDRX- | timeoffset-eDRX- |
| wakeUpSignalMinGap- | not | Short | Short |
| eDRX | reported | | |
| | 240 ms | timeoffset-eDRX- | timeoffset-eDRX- |
| | | Short | Short |
| | 1000 ms | timeoffset-eDRX- | timeoffset-eDRX- |
| | | Long | Long |
| | 2000 ms | timeoffset-eDRX- | timeoffset-eDRX- |
| | | Short | Long |

The timeoffset is used to determine the actual subframe g0 as follows (taking into
consideration resultant SFN and/or H-SFN wrap-around of this computation):

g0 = PO − timeoffset, where PO is the Paging Occasion subframe as defined in
clause 7.1

For UE using eDRX, the same timeoffset applies between the end of WUS and
associated first PO of the numPOs POs for all the WUS occurrences for a PTW.
The timeoffset, g0, is used to calculate the start of the WUS as defined in TS 36.213 [6].

***** END EXCERPT FROM 3GPP TS 36.304 *****

In essence, the UE will only use WUR, or timeOffset-eDRX-Long, if it is capable of starting up the main receiver as quickly as indicated by the value used in SI. If not, it will fall back to using timeOffset-eDRX-Short (without WUR).

FIG. 3 is an illustration of the use of eDRX and DRX WUS gaps for NB-IoT and LTE-M.

Since UEs share POs, the eNB may, in the worst case, have to transmit up to three WUSs for one PO, i.e., corresponding to timeoffsetDRX, timeoffset-eDRX-Short, and timeoffset-eDRX-Long.

In the Rel-16 Work Item Description (WID), it was agreed that WUS should be further developed to also include UE grouping, such that the number of UEs that are triggered by a WUS is further narrowed down to a smaller subset of the UEs that are associated with a specific Paging Occasion (PO):

The objective is to specify the following set of improvements for machine-type communications for BL. CE UEs.

Improved DL Transmission Efficiency and/or UE Power Consumption:
. . .
Specify support for UE-group wake-up signal (WUS) [RAN1, RAN2, RAN4]

The purpose is to reduce the false paging rate, i.e., to avoid that a given UE is unnecessarily woken up by a WUS transmission intended for another UE. This feature is referred to as Rel-16 group WUS, or GWUS. However, this is not directly related to WUR and will not further be explained here.

### Rel-17 NR PEI

In 3GPP Rel-17, discussions started on introducing a WUS for NR, then called ‘Paging Early Indication’ (PEI). However, since at the time no coverage enhancement was specified for NR, the only gain for Rel-17 PEI was for scenarios where the small fraction of UEs are in bad coverage and with large synchronization error due to the use of longer DRX cycles. The gain for such UEs was that, with the use of PEI, they would typically only have to acquire one Synchronization Signal Block (SSB) before decoding PEI, instead of up to three SSBs if PEI is not used (value according to UE vendors). So, for most UEs, Rel-17 PEI will result in gains or increased performance.

Rel-17 PEI will also support UE grouping for false paging reduction, similar to the Rel-16 GWUS above, which will have some gains at higher paging load.

In RAN #93e, it was agreed that PEI will be PDCCH-based, as seen in from the next subsection, making it much less interesting for WUR (i.e., the main baseband receiver is required for decoding PEI).

### Rel-18 NR WUR

In 3GPP Rel-18, there has been rather large interest to introduce WUR for NR. As explained above, the only specification support needed to be able to use a WUR in the UE is the specification of a WUS and a long enough time gap between the WUS and the PDCCH in the PO (to allow the UE to start up the main receiver). Therefore, the main difference to Rel-17 PEI is the WUS in Rel-18 should not be PDCCH-based and allow for a simpler and low power receiver, i.e., WUR with simple modulation and detection techniques (e.g., using on-off keying (OOK) modulation and non-coherent detection).

In Rel-18, a study item on “low-power wake-up signal and receiver for NR” was approved. The relevant justification and objective sections are copied in the following excerpt from RP-213645:

***** START EXCERPT FROM RP-213645 *****

• Justification
5G systems are designed and developed targeting for both mobile telephony and
vertical use cases. Besides latency, reliability, and availability, UE energy efficiency is
also critical to 5G. Currently, 5G devices may have to be recharged per week or day,
depending on individual's usage time. In general, 5G devices consume tens of milliwatts
in RRC idle/inactive state and hundreds of milliwatts in RRC connected state. Designs
to prolong battery life is a necessity for improving energy efficiency as well as for better
user experience.
Energy efficiency is even more critical for UEs without a continuous energy source, e.g.,
UEs using small rechargeable and single coin cell batteries. Among vertical use cases,
sensors and actuators are deployed extensively for monitoring, measuring, charging,
etc. Generally, their batteries are not rechargeable and expected to last at least few
years as described in TR 38.875. Wearables include smart watches, rings, eHealth
related devices, and medical monitoring devices. With typical battery capacity, it is
challenging to sustain up to 1-2 weeks as required.
The power consumption depends on the configured length of wake-up periods, e.g.,
paging cycle. To meet the battery life requirements above, eDRX cycle with large value
is expected to be used, resulting in high latency, which is not suitable for such services
with requirements of both long battery life and low latency. For example, in fire detection
and extinguishment use case, fire shutters shall be closed and fire sprinklers shall be
turned on by the actuators within 1 to 2 seconds from the time the fire is detected by
sensors, long eDRX cycle cannot meet the delay requirements. eDRX is apparently not
suitable for latency-critical use cases. Thus, the intention is to study ultra-low power
mechanism that can support low latency in Rel-18, e.g. lower than eDRX latency.
Currently, UEs need to periodically wake up once per DRX cycle, which dominates the
power consumption in periods with no signalling or data traffic. If UEs are able to wake
up only when they are triggered, e.g., paging, power consumption could be dramatically
reduced. This can be achieved by using a wake-up signal to trigger the main radio and a
separate receiver which has the ability to monitor wake-up signal with ultra-low power
consumption. Main radio works for data transmission and reception, which can be
turned off or set to deep sleep unless it is turned on.
The power consumption for monitoring wake-up signal depends on the wake-up signal
design and the hardware module of the wake-up receiver used for signal detecting and
processing.
The study should primarily target low-power WUS/WUR for power-sensitive, small form-
factor devices including IoT use cases (such as industrial sensors, controllers) and
wearables. Other use cases are not precluded, e.g. XR/smart glasses, smart phones.

| | |
|---|---|
| • | Objective of SI |

As opposed to the work on UE power savings in previous releases, this study will not
require existing signals to be used as WUS. All WUS solutions identified shall be able to
operate in a cell supporting legacy UEs. Solutions should target substantial gains
compared to the existing Rel-15/16/17 UE power saving mechanisms. Other aspects
such as detection performance, coverage, UE complexity, should be covered by the
evaluation.
The study item includes the following objectives:

| • | Identify evaluation methodology (including the use cases) & KPIs [RAN1] | |
|---|---|---|
| | ∘ | Primarily target low-power WUS/WUR for power-sensitive, small form-factor |
| | | devices including IoT use cases (such as industrial sensors, controllers) |
| | | and wearables |

| | |
|---|---|
| ▪ | Other use cases are not precluded |

| • | Study and evaluate low-power wake-up receiver architectures [RAN1, RAN4] | |
|---|---|---|
| • | Study and evaluate wake-up signal designs to support wake-up receivers [RAN1, | |
| | RAN4] | |
| • | Study and evaluate L1 procedures and higher layer protocol changes needed to | |
| | support the wake-up signals [RAN2, RAN1] | |
| • | Study potential UE power saving gains compared to the existing Rel-15/16/17 UE | |
| | power saving mechanisms and their coverage availability, as well as latency | |
| | impact. System impact, such as network power consumption, coexistence with | |
| | non-low-power-WUR UEs, network coverage/capacity/resource overhead should | |
| | be included in the study [RAN1] | |
| | ∘ | Note: The need for RAN2 evaluation will be triggered by RAN1 when |
| | | necessary. |

***** END EXCERPT FROM RP-213645 *****

For more details on, e.g., suggestions on WUR architecture and design, receiver power versus sensitivity trade-off see e.g., RP-212005, RP-212254, RP-212367, and RP-212427 which were submitted to RAN3 #93-e.

The benefit of WUR is to reduce the energy consumption of the receiver such that, unless there is any paging and data for the UE, it can remain in a power saving state. This will extend the battery life of the device, or alternatively enable shorter downlink latency (shorter DRX) at a fixed battery life. For short-range communication, the WUR power can be low enough (˜3 microwatts (uW)) that this can even, in combination with energy harvesting, enable that the WUR is continuously on (i.e., DRX or duty-cycling is not used) without the need for a battery. This can be considered as a key enabler of battery-less devices towards 6^{th} Generation (6G).

### IEEE WUR

In Institute of Electronics and Electrical Engineers (IEEE), the support for WUR has been specified to a greater extent than in 3GPP. That is, the focus was on low power WUR from start and the design uses WUR not only for receiving the WUS but also other control signals and signaling, such as synchronization and mobility information. This allows the stations (corresponding to UEs in 3GPP) to only use the WUR when there is no user-plane data transmission ongoing.

Similar to the 3GPP solution, the use of WUR is only enabled in stations and not in access points (APs), that is for downlink communication only. The AP advertises that it has WUR operation capability, along with WUR configuration parameters which includes, among other information, in which band/channel WUR is operational, which can be different from the band/channel used for data transmission using the main receiver, e.g., WUR in 2.4 Gigahertz (GHz) band but data communication in 5 GHz band. Also note that the WUR operating channel is advertised in the beacon, and that the WUR discovery operating channel may be different from the WUR operating channel. Stations can then request to be configured with WUR mode of operation. This request has to be granted by the AP, and in case it is granted, the station is further configured/setup for WUR mode of operation (the configuration is only valid for the connection to the associated AP, and further the configuration must be torn down/de-configured if WUR is not be used anymore). Both continuous WUR (receiver open all the time) and duty-cycled WUR (receiver only open during preconfigured time slots) mode of operations are supported. For the latter the length of the duty-cycles and on-time during wake up is part of the WUR configuration.

Unlike the 3GPP solution, the WUR operation mode is a “sub-state” of the regular operation and, upon the detection of a WUS transmission from the AP, the station will resume the power saving mechanism it was configured with before entering the WUR operation mode. That is, IEEE has specified a number of different power saving mechanisms, and for example if duty-cycled monitoring of the downlink has been configured for the station it will switch to that upon detection of the WUS (i.e., unlike the specified 3GPP mechanism which only covers paging, and the UE will continue to monitor PDCCH if WUS is detected). In this way, the IEEE WUR functionality is more general, and stills allows for the station to upon detection of WUS “monitor paging” by checking in the beacon from the AP for which stations there is data, or for the station to directly respond with an uplink transmission.

A station receiving the IEEE WUS must synchronize to the wireless medium prior to performing any transmissions, i.e., using sync info in the beacon from the AP (typically transmitted every 100 milliseconds (ms)) or from the transmission to another station. Synchronization to the wireless medium refers to the following in IEEE 802.11: a station changing from sleep to awake in order to transmit must perform channel clear assessment until it receives one or more frames that allow it to correctly set the virtual carrier sensing. This is to prevent collisions with transmissions from hidden nodes. Essentially the virtual carrier sensing tells a station to defer for a time period even if the wireless medium appears to be idle and can be set by receiving frames that indicate the duration of an ongoing frame exchange. Note that in WiFi typically one beacon transmission is enough to sync for the station (i.e., no need to acquire several transmission due to poor coverage). Unlike operation in licensed bands, the station also has to apply carrier sensing, and also possibly re-acquire channel sensing parameters, before uplink transmission.

The physical WUS in IEEE contains complete frames which have to be processed by the station. The drawback with this design is that it requires more processing and handling and processing in the station compared to a simple WUR design which triggers one pre-defined activity in case WUS is detected. The benefit is that it contains more information, and the solution is more general. The IEEE WUS contains information to indicate if the WUS is a WUR sync beacon (see below), a WUR discovery beacon (see below), or a regular WUS (intended to wake the station up). The WUS can also contain proprietary frames, which could e.g., be used to directly turn actuators on/off. The transmission uses OOK modulation, using Manchester coding, but is using multi-carrier OOK which can be generated by an Orthogonal Frequency Division Multiplexing (OFDM) transmitter (i.e., WUR can be enabled as a software upgrade in APs). The WUS is 4 MHz wide, but a whole 20 MHz channel is reserved. The WUS starts with a 20 MHz legacy preamble (to allows other stations to perform carrier sense) followed by 4 MHz Manchester coded OOK. Two data rates are supported: 62.5 kilobits per second (kbps) and 250 kbps, and link adaptation is up to the AP (each packet is self-contained and includes the data rate, i.e. in the WUR there are two possible sync words used to signal the data rate).

The WUS can contain the following information:
Station ID, or group ID (grouping of stations is supported)· Payload up to 22 bytes.
Short frames contain only basic info; which WUR frame type+addressing.
Ordinary frames contain control info, and in addition proprietary info.
WUR beacons contain BSS-ID, sync information, time counter.
Similar structure for WUS and WUR beacons (sync words indicate the data rate, the station can then detect the header, from this the station can tell if it is WUS or beacon, then check body).
WUR discovery frames contain mobility related information to allow for lower power scan (see below).

Regarding mobility, both WUR sync beacons and WUR discovery beacons have been specified, which only requires the WUR to be used for reception, such that stations can stay in the WUR operation mode unless there is data transmission for the station. I.e., stations only need to switch back to legacy power savings mode (PSM) upon WUS detection (or when moving to a new AP). WUR sync beacons are used by stations to obtain rough synchronization (for data transmission the legacy beacon must still be acquired), and WUR discovery beacons are used to carry (legacy) mobility information to enable quick/low energy scanning (allowing stations, only using the WUR, to get information related to local and roaming scans for nearby APs, e.g. SSID and main radio operating channels, if the channel quality should deteriorate).

That is, in the WUR discovery beacon the AP can indicate one or more BSS (basic service set, and the BSS-ID has a one-to-one mapping with the assigned SSID name) in which WUR is supported such that stations do not have to scan all frequencies/channels. Since the WUR discovery beacon contains the legacy mobility information, which means there is some duplication/redundancy in the broadcasted information. This allows for low power scanning, using only the WUR. Note however that mobility in IEEE is restricted to the same AP, and that hand-over between APs etc. is not supported in the same way as in 3GPP. If a station in WUR operation mode moves to a new AP, it would have to move out of WUR operation mode and use the main receiver to obtain the beacon, sync, configuration, and associate to the new AP.

### SUMMARY

Systems and methods are disclosed that relate to User Equipment (UE) addressing with Wake-Up Signal (WUS) codes. In one embodiment, a method performed by a UE comprises monitoring a WUS occasion for two or more WUSs that correspond to two or more codes, respectively, that together represent a Wake-Up Group Identifier (WUGI) assigned to the UE. The method further comprises performing one or more actions based on a result of the monitoring. In this manner, UE or UE group addressing is provided for WUS.

In one embodiment, performing the one or more actions comprises waking a main receiver of the UE if the WUGI is detected via the monitoring and otherwise refraining from waking the main receiver.

In one embodiment, each of the two or more codes is a code from a predefined set of orthogonal codes. In another embodiment, each of the two or more codes is a code from a predefined set of codes having sufficient auto-correlation properties to be distinguishable to UEs. In one embodiment, the predefined set of codes comprises 2^{w} codes where w is number of bits that can be encoded in a WUS transmission. In one embodiment, the WUGI consists of g bits wherein g>w. In one embodiment, the two or more codes consist of

$$M = ⌈ \frac{g}{w} ⌉ codes .$$

In one embodiment, each code from the predefined set of codes represents a different set of values for w bits, and the sets of values for the w bits represented by the two or more WUSs for the WUGI assigned to the UE.

In one embodiment, the method further comprises receiving, from a network node, information that assigns the WUGI to the UE.

In one embodiment, the WUGI is derived by the UE based on a UE identity of the UE.

In one embodiment, the WUGI is derived by the UE based on bits of a UE identity of the UE that are not already used for determining a paging frame or paging occasion.

In one embodiment, the two or more WUSs are consecutive WUSs in the WUS occasion.

In one embodiment, bits of the WUGI are distributed over the two or more WUSs in accordance with one or more predefined or configured rules. In one embodiment, w is the number of bits that can be encoded in a WUS transmission, g is the number of bits in the WUGI, the two or more WUSs consist of

$$M = ⌈ \frac{g}{w} ⌉ bits ,$$

and Mw−g paddings bits are appended to a binary representation of the WUGI that is represented by the two or more WUSs.

In one embodiment, monitoring the WUS occasion for the two or more WUSs that correspond to the two or more codes, respectively, that together form the WUGI assigned to the UE comprises monitoring for all of the two or more WUSs in the WUS occasion.

In one embodiment, monitoring the WUS occasion for the two or more WUSs that correspond to the two or more codes, respectively, that together represent the WUGI assigned to the UE comprises ceasing to monitor the WUS occasion upon determining that a WUGI transmitted in the WUS occasion does not match the WUGI assigned to the UE.

In one embodiment, the WUS occasion comprises WUSs that address only one WUGI.

In one embodiment, the WUS occasion comprises WUSs that address two or more WUGIs.

In one embodiment, the WUGI assigned to the UE is uniquely assigned to the UE.

In one embodiment, the WUGI assigned to the UE is assigned to a group of UEs, and the group of UEs comprises two or more UEs.

In one embodiment, the WUGI is a 5th Generation (5G) Subscriber Temporary Mobile Subscriber Identity (S-TMSI) of the UE.

In one embodiment, the two or more codes are repeated over multiple WUS transmissions.

Corresponding embodiments of a UE are also disclosed. In one embodiment, a UE is adapted to monitor a WUS occasion for two or more WUSs that correspond to two or more codes, respectively, that together represent a WUGI assigned to the UE and perform one or more actions based on a result of the monitoring.

In one embodiment, a UE comprises a communication interface comprising a main receiver and a wake-up receiver, and processing circuitry associated with the communication interface. The processing circuitry is configured to cause the UE to monitor a WUS occasion for two or more WUSs that correspond to two or more codes, respectively, that together represent a WUGI assigned to the UE and perform one or more actions based on a result of the monitoring.

Embodiments of a method performed by a network node are also disclosed. In one embodiment, a method performed by a network node comprises transmitting two or more WUSs in a WUS occasion, wherein the two or more WUSs correspond to two or more codes, respectively, that together represent a Wake-Up Group Identifier (WUGI) assigned to at least one UE.

In one embodiment, the two or more codes are two or more codes from a predefined set of orthogonal codes. In another embodiment, the two or more codes are two or more codes from a predefined set of codes having sufficient auto-correlation properties to be distinguishable to UEs. In one embodiment, the predefined set of codes comprises 2^{w} codes where w is number of bits that can be encoded in a WUS transmission. In one embodiment, the WUGI consists of g bits wherein g>w. In one embodiment, the two or more codes consist of

$$M = ⌈ \frac{g}{w} ⌉ codes .$$

In one embodiment, each code from the predefined set of codes represents a different set of values for w bits, and the sets of values for the w bits represented by the two or more WUSs for the WUGI assigned to the UE.

In one embodiment, the method further comprises transmitting, from a network node, information that assigns the WUGI to the at least one UE.

In one embodiment, the WUGI is derived based on a UE identity of the at least one UE.

In one embodiment, the WUGI is derived based on bits of a UE identity of the UE that are not already used for determining a paging frame or paging occasion.

In one embodiment, the two or more WUSs are in consecutive WUS occasions.

In one embodiment, bits of the WUGI are distributed over the two or more WUSs in accordance with one or more predefined or configured rules. In one embodiment, w is the number of bits that can be encoded in a WUS transmission, g is the number of bits in the WUGI, the two or more WUSs consist of

$$M = ⌈ \frac{g}{w} ⌉ ,$$

and Mw−g paddings bits are appended to a binary representation of the WUGI.

In one embodiment, the WUS occasion comprises WUSs that address only one WUGI.

In one embodiment, the WUS occasion comprises WUSs that address two or more WUGIs.

In one embodiment, the at least one UE is a single UE, and the WUGI is assigned to the single UE.

In one embodiment, the at least one UE is a group of two or more UEs, and the WUGI assigned to the group of UEs.

In one embodiment, the WUGI is a 5G-S-TMSI of the UE.

In one embodiment, the two or more codes are repeated over multiple WUS transmissions.

Corresponding embodiments of a network node are also disclosed. In one embodiment, a network node for a wireless communications network, the network node adapted to transmit two or more WUSs in a WUS occasion, wherein the two or more WUSs correspond to two or more codes, respectively, that together represent a WUGI assigned to at least one UE.

In one embodiment, a network node for a wireless communications network comprises a communication interface comprising radio front-end circuitry, and processing circuitry associated with the communication interface. The processing circuitry is configured to cause the network node to transmit two or more WUSs in a WUS occasion, wherein the two or more WUSs correspond to two or more codes, respectively, that together represent a WUGI assigned to at least one UE.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 is an illustration of the location of a Wake-Up Signal (WUS) and the paging occasion to which it is associated;

FIG. 2 illustrates that, due to coverage enhancements, the WUS can be of variable length depending on the coverage of the User Equipment (UE);

FIG. 3 is an illustration of the use of Discontinuous Reception (DRX) and enhanced DRX (eDRX) WUS gaps for Narrowband Internet of Things (NB-IoT) and Long Term Evolution (LTE) for Machine Type Communication (MTC), i.e., LTE-M;

FIG. 4 illustrates transmission of multiple WUS Identifiers (WUSIDs) in sequence at the beginning of a WUS occasion, in accordance with an embodiment of the present disclosure;

FIG. 5 shows an example where a gNodeB (gNB) wants to wake up UE A and a second UE B decodes some of the WUSs until it realizes that the Wake-Up Group Identifier (WUGI) represented by the WUSs does not match its own WUGI, in accordance with an embodiment of the present disclosure;

FIG. 6 illustrates an example in which two UEs are addressed in a single WUS occasion and a third UE is not addressed in the single WUS occasion, in accordance with an embodiment of the present disclosure;

FIG. 7 illustrates the operation of a network node and a UE in accordance with at least some of the embodiments described herein;

FIG. 8 shows an example of a communication system in accordance with some embodiments;

FIG. 9 shows a UE in accordance with some embodiments;

FIG. 10 shows a network node in accordance with some embodiments;

FIG. 11 is a block diagram of a host, which may be an embodiment of the host of FIG. 8, in accordance with various aspects described herein;

FIG. 12 is a block diagram illustrating a virtualization environment in which functions implemented by some embodiments may be virtualized; and

FIG. 13 shows a communication diagram of a host communicating via a network node with a UE over a partially wireless connection in accordance with some embodiments.

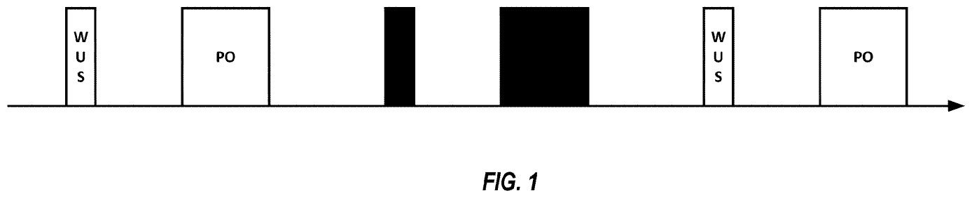

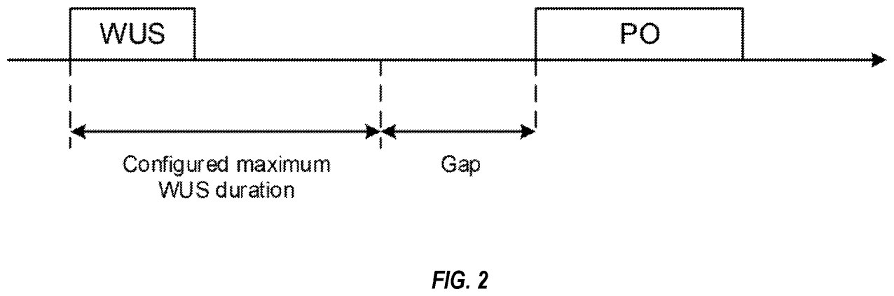

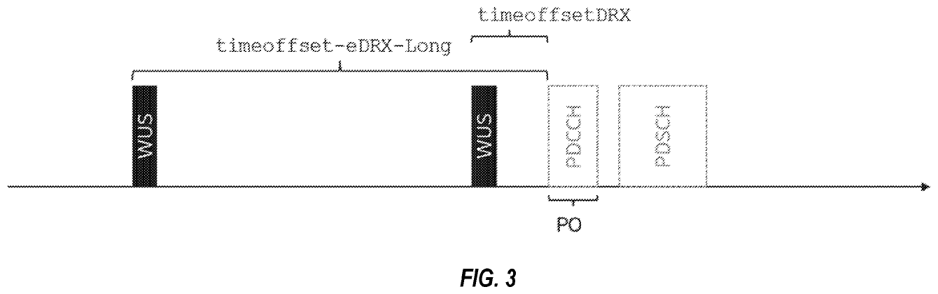

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

There currently exist certain challenge(s). There are two possible solutions for 3rd Generation Partnership Project (3GPP) Rel-18 New Radio (NR) Wake-Up Receiver (WUR):
1) The Wake-Up Signal (WUS) can include a payload. This payload may contain a User Equipment (UE) identifier or a group identifier that determines which UEs should wake up and start monitoring Physical Downlink Control Channel (PDCCH) for paging.
2) WUS does not include a payload. To improve physical (PHY) layer performance, the WUS is generated based on a set of orthogonal or quasi-orthogonal sequences.

Addressing a specific UE or a group of UEs is still of importance even in case option 2 is standardized, and a method to transmit the information regarding the UE identity or group identity being addressed is still required for option 2.

Certain aspects of the disclosure and their embodiments may provide solutions to these or other challenges. A solution has been proposed for how to address specific UEs by transmitting their 48-bit 5^{th} Generation (5G) Subscriber Temporary Mobile Subscriber Identity (5G-S-TMSI) in one or multiple linked WUS, where each WUS record contains the full UE identifier or part of the UE identifier.

Nevertheless, it is not clear whether a payload can be transmitted in the WUS. It is possible that the WUS will consist of a signal generated from a set of pre-determined orthogonal codes

Systems and methods are disclosed herein for addressing specific UEs assuming that the WUS does not carry a payload and consists of one of these orthogonal codes instead (i.e. similar to the sequence based WUS used in Rel-15 Narrowband Internet of Things (NB-IoT) and Long Term Evolution (LTE) for Machine Type Communication (MTC), i.e., LTE-M).

In the existing technology (e.g. NB-IoT and LTE-M), a UE will be assigned a certain WUS code sequence which it monitors for in each WUS occasion. If detected, it means there is paging for the UE, and the UE will wake up the main receiver to monitor paging in the paging occasion (PO) associated with the WUS occasion (following legacy procedure, i.e. monitor PDCCH scrambled with Paging Radio Network Temporary Identifier (P-RNTI)). If not detected, there is no UE action, and the UE will go back to a sleep state waiting for the subsequent WUS occasions.

In one embodiment of the present disclosure, each WUS is generated from a pre-determined orthogonal code out of a pool of 2^{w} options. Strictly, there may be no need for orthogonal codes, but that the codes have good auto-correlation properties so that they are clearly distinguishable to UEs. Each such code is referred to as a Wake-Up Signal Identifier (WUSID, similar to the Random Access Preamble Identifier (RAPID) defined for Random Access Preambles) so that the WUSID is in the range [0, 2^{w}−1]. In one embodiment, w is chosen based on one or more physical (PHY) layer considerations. For example, the larger the set of codes that can be transmitted in a WUS (i.e., the larger w is), the higher the probability of a false or wrong detection by the receiving UE but the more information can be encoded in the WUS. Ultimately, w represents the number of information bits that can be encoded in a WUS transmission and is, in one embodiment, chosen to balance the detection performance and the need for more granularity in addressing UEs using the smallest amount of resources possible.

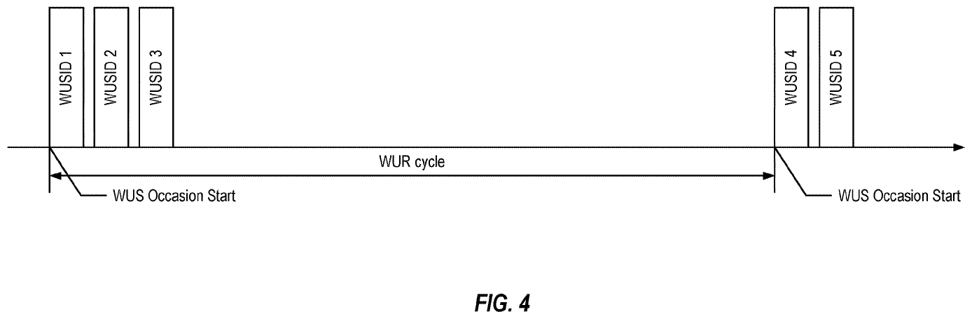

In one embodiment, it is assumed that, at the beginning of a WUS occasion, it is possible to transmit multiple WUSIDs in sequence and each UE is able to receive them with enough time accuracy. The resulting behavior over time is shown in FIG. 4. I.e., the start time of the WUS monitoring occasions will be determined by configuration, but the end time will be flexible as described below.

In one embodiment, each UE is assigned with a g bits long identifier by the network, which will from hereon be referred to herein by the exemplary term “WUS UE Group Index” or WUGI. As a consequence, up to N_{WUGI}=2^{g} UE groups can be configured. Notice that g is dimensioned based on the expected number of UEs in the cell or in a specific area in WUR mode or the desired granularity in addressing the UEs with a single WUS transmission. Note that g should be greater than w.

In one embodiment, the assignment of the WUGI may happen before the UE enters the sleep mode and starts monitoring WUS (e.g.: while in CONNECTED mode through UE-specific Radio Resource Control (RRC) signaling).

In another embodiment, the WUGI is derived from the UE identity. This may be particularly beneficial for UEs in the RRC idle state in which no UE-specific configuration is possible. By deriving the WUGI from the UE identity, UEs sharing the same PO would typically be distributed uniformly in different WUS UE groups associated with different WUGIs to minimize false paging (i.e., that a UE is unnecessarily woken up to monitor paging when another UE is being paged). In another option, UEs can be distributed to WUS groups according to their traffic pattern, e.g., UEs with high paging rate and low paging rate are divided into different groups to reduce the false paging. In one example embodiment, the UE determines which WUGI to monitor by the following equation, i.e., using the bits in the UE_ID not already used for determining the paging frame (PF), or the PO, to avoid that all UEs sharing a PO are assigned the same Group Index (see 3GPP TS 38.304 for the definition of N and Ns etc.):

$$WUGI = floor ( UE\_ID / ( N * Ns ) ) mod {N}_{WUGI}$$

The WUGI may be valid within a WUR area (e.g., in case of a UE-specific RRC configuration) or be valid in the entire network (e.g.: in case of derivation from the UE Identifier in RRC_Idle). It is up to network implementation to avoid that a UE receives a WUGI meant for another UE in a neighbor WUR area.

With these assumptions, each WUGI can be represented by

$$M = ⌈ \frac{g}{w} ⌉ WUSIDs$$

delivered in consecutive WUS transmissions, where ┌.┐ is the ceiling operation. In other words, each WUS contains a WUSID representing a w bit portion of the WUGI, starting for example from the most significant bits.

In an example, assume that 16 codes are used to generate WUS (w=4) and the WUGI is 12 bits long (g=12, N_{WUGI}=2^{g}=4096). This means that each WUGI can be delivered with

$$M = ⌈ \frac{g}{w} ⌉ = 3$$

consecutive WUSIDS.

If a UE is assigned with a WUGI=0xABC (hexadecimal notation), the corresponding sequence of 3 WUSIDs can be determined by following these steps:
Binary representation of the WUGI: 0b101010111100
WUGI bits are split in w bits long segments: 0b1010, 0b1011, 0b1100
Each segment is the binary representation of the WUSID: 0b1010=10, 0b1011=11, 0b1100=12
3 WUSs will be generated, the first with WUSID=10, the second with WUSID=11 and the last with WUSID=12

In another embodiment, the WUGI bits are distributed over multiple WUS transmissions based on some rules, especially in case w is not a multiple of g. For example, with g WUGI bits, w sequence size, and

$$M = ⌈ \frac{g}{w} ⌉ WUS$$

transmissions/occasions, we can have:
“Zero padding” option: Before determining the WUSIDs according to the procedure above, Mw−g paddings bits are appended at the end of the binary representation of the WUGI. In this way the first M−1 WUSs will carry exactly w bits of information while the last WUS will carry the last g−(M−1)w bits of the WUGI.
“Flexible Zero-padding” option: In a more general case, one of the WUS transmissions is filled with the same amount of padding bits as mentioned above, and each of the other WUS transmissions carries w bits. The location of such WUS transmissions can be flexible (e.g., at the beginning, middle, or end of WUS occasions) and either hardcoded or configured by the network.
“Distributed Zero padding” option: To have the same amount of WUGI bits in each WUS transmissions, the padding bits can be uniformly distributed in each WUS. This can be done by adding uniformly the padding bits to the binary representation of the WUGI before the procedure described above or by adding the padding bits at the end of the binary representation and applying a bit-wise interleaving

In one embodiment, each UE is mandated to decode each WUS transmitted by the gNB, but in a further embodiment a UE can stop decoding the WUSs as soon as it realizes that the WUGI being transmitted does not match with its own assigned WUGI.

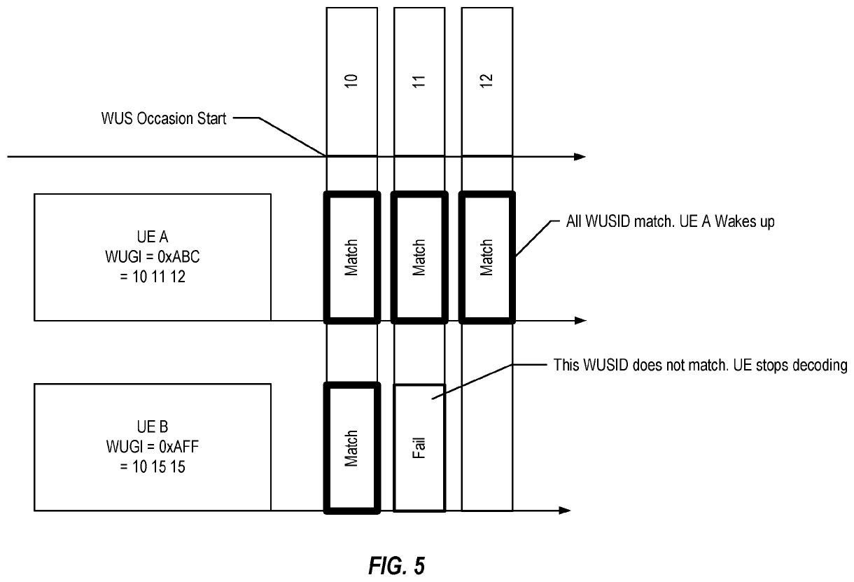

FIG. 5 shows an example where the gNodeB (gNB) wants to wake up UE A and a second UE B decodes some of the WUSs until it realizes the WUGI does not match its own. In the example, it is assumed that 16 codes are used to generate WUS (w=4) and the WUGI is 12 bits long (g=12, N_{WUGI}=2^{g}=4096). This means that each WUGI can be delivered with

$$M = ⌈ \frac{g}{w} ⌉ = 3$$

consecutive WUSIDS.

In FIG. 5, hexadecimal notation is used for the WUGI so that it is in the range 0x000 to 0xFFF. For convenience, in each UE box, the sequence of WUSIDs corresponding to the configured WUGI is shown.

In a further embodiment, the gNB can address more than 1 UE in the WUS Occasion. To do so it can simply keep sending further groups of WUSs. A UE stops decoding the WUSs as soon as it is addressed (and wakes up) or until it does not detect a WUS anymore (at the end of the WUS Occasion when all UEs have been addressed).

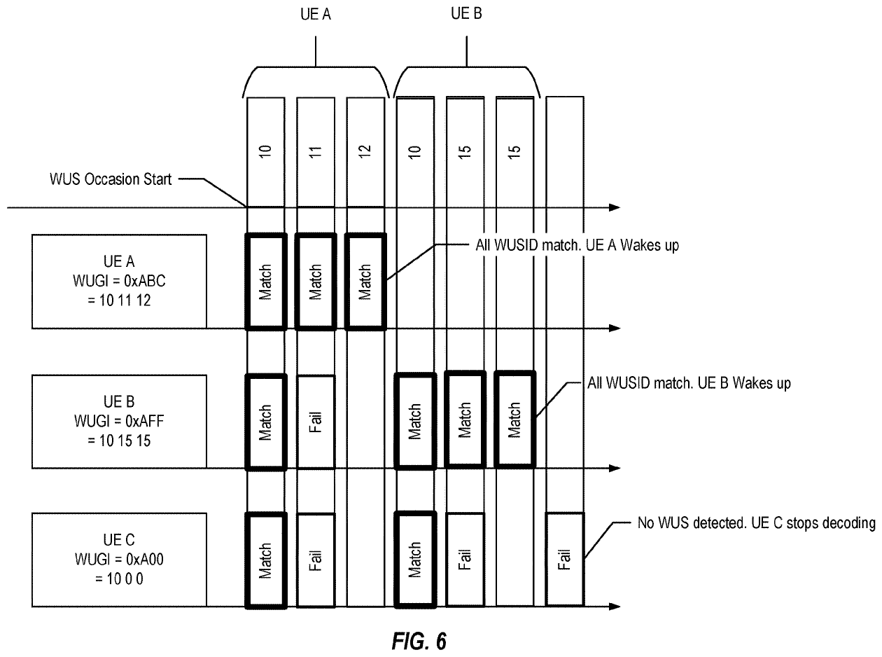

An example in FIG. 6 has the same assumptions as the previous example but now UE A and B are addressed and three UEs are represented.

In a further embodiment, the network can assign the same WUGI to multiple UEs to enable group-WUS (e.g.: UEs can be grouped so that are awakened at the same time because DL data is often expected for all these UEs at the same time).

In a further embodiment, one or more WUGIs can be reserved to implement special behaviors. For instance, WUGI=0x000 may indicate to all UEs to wake-up regardless of their assigned WUGI or to monitoring a few consecutive WUS occasions.

In a further embodiment, the WUGI is not used at all and the 48-bit 5G-S-TMSI is used instead. It would work in the same way as with g=48 and WUGI=5G-S-TMSI. If we assume 16 WUS codes (w=4) as in the examples above, it means that

$$⌈ \frac{g}{w} ⌉ = 12$$

subsequent WUS transmissions are needed to represent the full identifier, which might be too excessive in practical use cases. This further embodiment may be stated differently as follows: in this further embodiment, the WUGI is the 48-bit 5G-S-TMSI.

Depending on the coverage requirement, there might be a need for time repetitions to improve the coverage especially for low-power wake-up receivers. In one embodiment, a repetition factor R is introduced for transmitting WUGI. In this case, each of the WUSIDs is repeated over multiple WUS transmissions. The repetition factor can be different for different UEs depending on the coverage condition and UE capability (e.g., a higher repetition factor for UEs located at the cell edge).

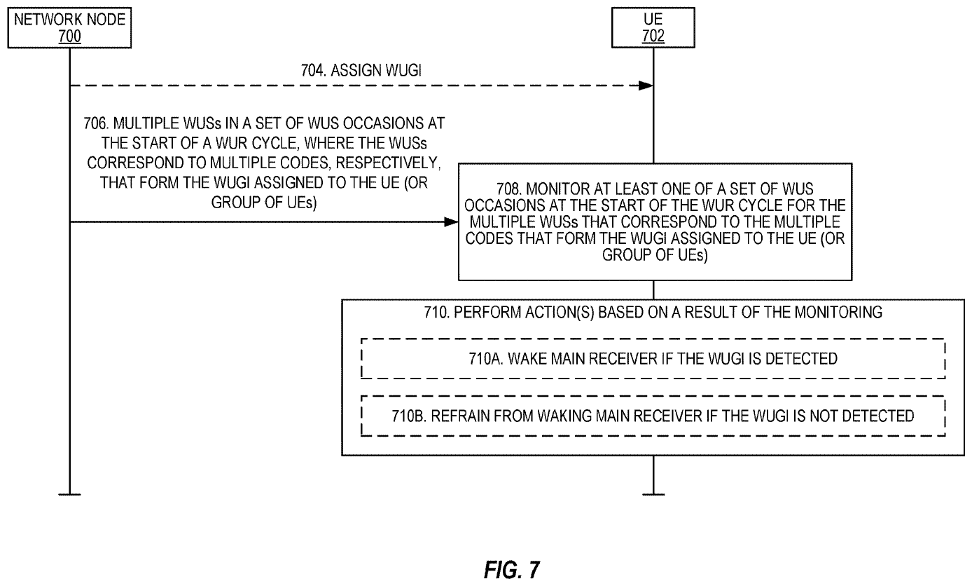

FIG. 7 illustrates the operation of a network node 700 and a UE 702 in accordance with at least some of the embodiments above. The network node 700 may be a base station (e.g., eNB, gNB, or the like) or a network node that performs at least some of the functionality of a base station (e.g., a gNB Central Unit (gNB-CU) or gNB Distributed Unit (gNB-DU) or the like). Note that optional steps are represented by dashed lines/boxes.

As illustrated, the network node 700 optionally sends information to the UE 702 that assigns a WUGI to the UE 702 (step 704). As discussed above, the WUGI may be derived by the network node 700 and/or the UE 702 based on a UE identifier of the UE. Alternatively, in one embodiment, the WUGI is an existing UE identifier of the UE 702 such as, e.g., a 5G-S-TMSI of the UE 702.

The network node 700 transmits multiple WUSs in a WUS occasion at a start of a WUR cycle, wherein the WUSs correspond to multiple codes, respectively, that form the WUGI assigned to the UE 700 (or a group of two or more UEs including the UE 702 (step 706). In other words, together, the multiple codes represent the WUGI (i.e., represent the bit sequence that is the WUGI) assigned to the UE 700, as described above. Note that the details above of the various embodiments related to the generation and transmission of the WUSs carrying the codes (WUSIDs) that form the WUGI assigned to a UE are equally applicable here to step 706.

At the UE 702, the UE 702 monitors the WUS occasion at the start of the WUR cycle for WUSs that correspond to the multiple codes that form the WUGI assigned to the UE 702 (or group of UEs including the UE 702) (step 708). Note that the details of the various embodiments described above relating to the monitoring performed by the UE to detect the WUSs corresponding to the codes (WUSIDs) that form the WUGI of the UE are equally applicable here to step 708). The UE 702 performs one or more actions based on a result of the monitoring in step 708 (step 710). More specifically, in one embodiment, the UE 702 wakes up a main receiver of the UE 702 if the WUGI is detected via the monitoring (step 710A) or refrains from waking up the main receiver of the UE 702 if the WUGI is not detected via the monitoring (step 710B).

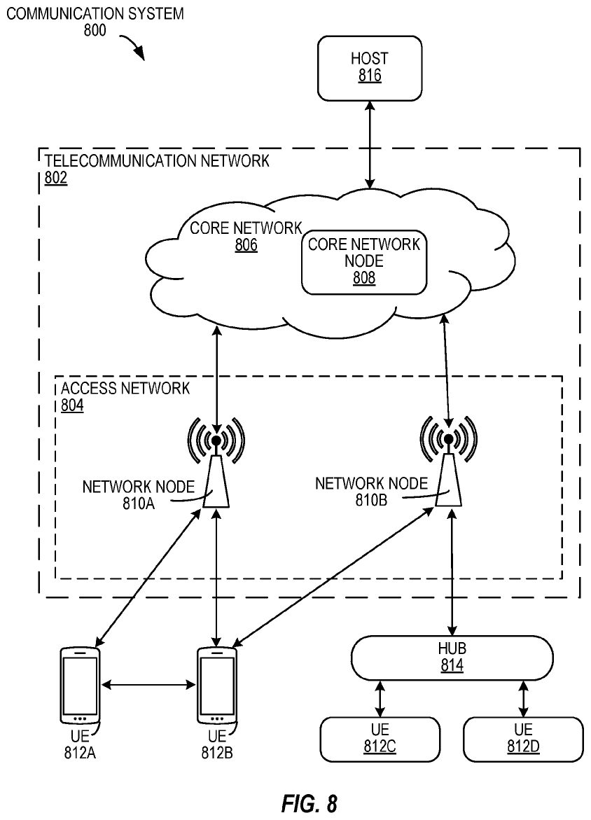

FIG. 8 shows an example of a communication system 800 in accordance with some embodiments.

In the example, the communication system 800 includes a telecommunication network 802 that includes an access network 804, such as a Radio Access Network (RAN), and a core network 806, which includes one or more core network nodes 808. The access network 804 includes one or more access network nodes, such as network nodes 810A and 810B (one or more of which may be generally referred to as network nodes 810), or any other similar Third Generation Partnership Project (3GPP) access node or non-3GPP Access Point (AP). The network nodes 810 facilitate direct or indirect connection of User Equipment (UE), such as by connecting UEs 812A, 812B, 812C, and 812D (one or more of which may be generally referred to as UEs 812) to the core network 806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 800 may include any number of wired or wireless networks, network nodes, UEs, and/or any other components or systems that may facilitate or participate in the communication of data and/or signals whether via wired or wireless connections. The communication system 800 may include and/or interface with any type of communication, telecommunication, data, cellular, radio network, and/or other similar type of system.

The UEs 812 may be any of a wide variety of communication devices, including wireless devices arranged, configured, and/or operable to communicate wirelessly with the network nodes 810 and other communication devices. Similarly, the network nodes 810 are arranged, capable, configured, and/or operable to communicate directly or indirectly with the UEs 812 and/or with other network nodes or equipment in the telecommunication network 802 to enable and/or provide network access, such as wireless network access, and/or to perform other functions, such as administration in the telecommunication network 802.

In the depicted example, the core network 806 connects the network nodes 810 to one or more hosts, such as host 816. These connections may be direct or indirect via one or more intermediary networks or devices. In other examples, network nodes may be directly coupled to hosts. The core network 806 includes one more core network nodes (e.g., core network node 808) that are structured with hardware and software components. Features of these components may be substantially similar to those described with respect to the UEs, network nodes, and/or hosts, such that the descriptions thereof are generally applicable to the corresponding components of the core network node 808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 816 may be under the ownership or control of a service provider other than an operator or provider of the access network 804 and/or the telecommunication network 802, and may be operated by the service provider or on behalf of the service provider. The host 816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 800 of FIG. 8 enables connectivity between the UEs, network nodes, and hosts. In that sense, the communication system 800 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 802 is a cellular network that implements 3GPP standardized features. Accordingly, the telecommunication network 802 may support network slicing to provide different logical networks to different devices that are connected to the telecommunication network 802. For example, the telecommunication network 802 may provide Ultra Reliable Low Latency Communication (URLLC) services to some UEs, while providing enhanced Mobile Broadband (eMBB) services to other UEs, and/or massive Machine Type Communication (mMITC)/massive Internet of Things (IoT) services to yet further UEs.

In some examples, the UEs 812 are configured to transmit and/or receive information without direct human interaction. For instance, a UE may be designed to transmit information to the access network 804 on a predetermined schedule, when triggered by an internal or external event, or in response to requests from the access network 804. Additionally, a UE may be configured for operating in single- or multi-Radio Access Technology (RAT) or multi-standard mode. For example, a UE may operate with any one or combination of WiFi, New Radio (NR), and LTE, i.e. be configured for Multi-Radio Dual Connectivity (MR-DC), such as Evolved UMTS Terrestrial RAN (E-UTRAN) NR-Dual Connectivity (EN-DC).

In the example, a hub 814 communicates with the access network 804 to facilitate indirect communication between one or more UEs (e.g., UE 812C and/or 812D) and network nodes (e.g., network node 810B). In some examples, the hub 814 may be a controller, router, content source and analytics, or any of the other communication devices described herein regarding UEs. For example, the hub 814 may be a broadband router enabling access to the core network 806 for the UEs. As another example, the hub 814 may be a controller that sends commands or instructions to one or more actuators in the UEs. Commands or instructions may be received from the UEs, network nodes 810, or by executable code, script, process, or other instructions in the hub 814. As another example, the hub 814 may be a data collector that acts as temporary storage for UE data and, in some embodiments, may perform analysis or other processing of the data. As another example, the hub 814 may be a content source. For example, for a UE that is a Virtual Reality (VR) headset, display, loudspeaker or other media delivery device, the hub 814 may retrieve VR assets, video, audio, or other media or data related to sensory information via a network node, which the hub 814 then provides to the UE either directly, after performing local processing, and/or after adding additional local content. In still another example, the hub 814 acts as a proxy server or orchestrator for the UEs, in particular in if one or more of the UEs are low energy IoT devices.

The hub 814 may have a constant/persistent or intermittent connection to the network node 810B. The hub 814 may also allow for a different communication scheme and/or schedule between the hub 814 and UEs (e.g., UE 812C and/or 812D), and between the hub 814 and the core network 806. In other examples, the hub 814 is connected to the core network 806 and/or one or more UEs via a wired connection. Moreover, the hub 814 may be configured to connect to a Machine-to-Machine (M2M) service provider over the access network 804 and/or to another UE over a direct connection. In some scenarios, UEs may establish a wireless connection with the network nodes 810 while still connected via the hub 814 via a wired or wireless connection. In some embodiments, the hub 814 may be a dedicated hub—that is, a hub whose primary function is to route communications to/from the UEs from/to the network node 810B. In other embodiments, the hub 814 may be a non-dedicated hub—that is, a device which is capable of operating to route communications between the UEs and the network node 810B, but which is additionally capable of operating as a communication start and/or end point for certain data channels.

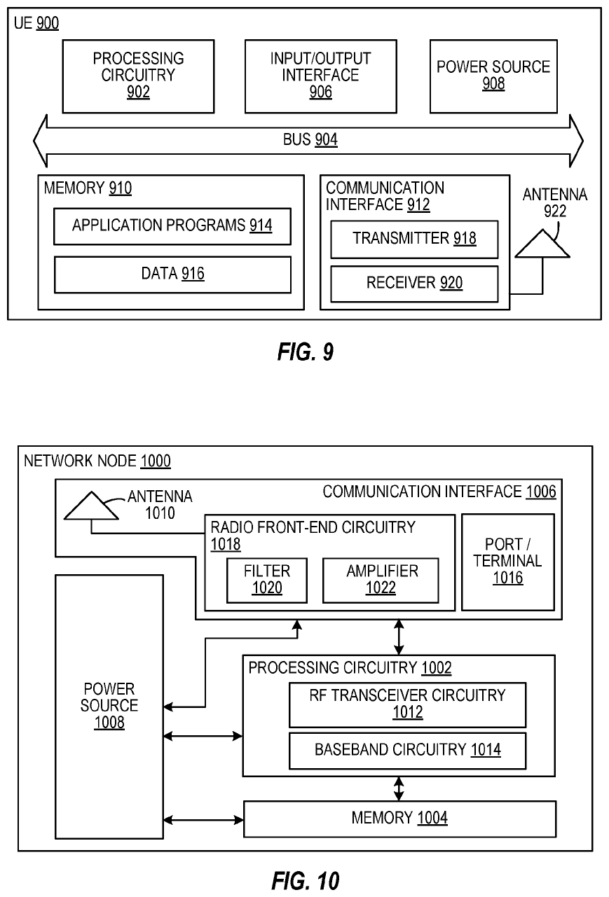

FIG. 9 shows a UE 900 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 900 includes processing circuitry 902 that is operatively coupled via a bus 904 to an input/output interface 906, a power source 908, memory 910, a communication interface 912, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 902 is configured to process instructions and data and may be configured to implement any sequential state machine operative to execute instructions stored as machine-readable computer programs in the memory 910. The processing circuitry 902 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 902 may include multiple Central Processing Units (CPUs).

In the example, the input/output interface 906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 908 is structured as a battery or battery pack. Other types of power sources, such as an external power source (e.g., an electricity outlet), photovoltaic device, or power cell, may be used. The power source 908 may further include power circuitry for delivering power from the power source 908 itself, and/or an external power source, to the various parts of the UE 900 via input circuitry or an interface such as an electrical power cable. Delivering power may be, for example, for charging the power source 908. Power circuitry may perform any formatting, converting, or other modification to the power from the power source 908 to make the power suitable for the respective components of the UE 900 to which power is supplied.

The memory 910 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 910 includes one or more application programs 914, such as an operating system, web browser application, a widget, gadget engine, or other application, and corresponding data 916. The memory 910 may store, for use by the UE 900, any of a variety of various operating systems or combinations of operating systems.

The memory 910 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 910 may allow the UE 900 to access instructions, application programs, and the like stored on transitory or non-transitory memory media, to off-load data, or to upload data. An article of manufacture, such as one utilizing a communication system, may be tangibly embodied as or in the memory 910, which may be or comprise a device-readable storage medium.

The processing circuitry 902 may be configured to communicate with an access network or other network using the communication interface 912. The communication interface 912 may comprise one or more communication subsystems and may include or be communicatively coupled to an antenna 922. The communication interface 912 may include one or more transceivers used to communicate, such as by communicating with one or more remote transceivers of another device capable of wireless communication (e.g., another UE or a network node in an access network). Each transceiver may include a transmitter 918 and/or a receiver 920 appropriate to provide network communications (e.g., optical, electrical, frequency allocations, and so forth). Moreover, the transmitter 918 and receiver 920 may be coupled to one or more antennas (e.g., the antenna 922) and may share circuit components, software, or firmware, or alternatively be implemented separately.

In the illustrated embodiment, communication functions of the communication interface 912 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 912, or via a wireless connection to a network node. Data captured by sensors of a UE can be communicated through a wireless connection to a network node via another UE. The output may be periodic (e.g., once every 15 minutes if it reports the sensed temperature), random (e.g, to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 900 shown in FIG. 9.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 10 shows a network node 1000 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1000 includes processing circuitry 1002, memory 1004, a communication interface 1006, and a power source 1008. The network node 1000 may be composed of multiple physically separate components (e.g., a Node B component and an RNC component, or a BTS component and a BSC component, etc.), which may each have their own respective components. In certain scenarios in which the network node 1000 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 1000 may be configured to support multiple RATs. In such embodiments, some components may be duplicated (e.g., separate memory 1004 for different RATs) and some components may be reused (e.g., an antenna 1010 may be shared by different RATs). The network node 1000 may also include multiple sets of the various illustrated components for different wireless technologies integrated into network node 1000, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 1000.

The processing circuitry 1002 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 1000 components, such as the memory 1004, to provide network node 1000 functionality.

In some embodiments, the processing circuitry 1002 includes a System on a Chip (SOC). In some embodiments, the processing circuitry 1002 includes one or more of Radio Frequency (RF) transceiver circuitry 1012 and baseband processing circuitry 1014. In some embodiments, the RF transceiver circuitry 1012 and the baseband processing circuitry 1014 may be on separate chips (or sets of chips), boards, or units, such as radio units and digital units. In alternative embodiments, part or all of the RF transceiver circuitry 1012 and the baseband processing circuitry 1014 may be on the same chip or set of chips, boards, or units.

The memory 1004 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 1002. The memory 1004 may store any suitable instructions, data, or information, including a computer program, software, an application including one or more of logic, rules, code, tables, and/or other instructions capable of being executed by the processing circuitry 1002 and utilized by the network node 1000. The memory 1004 may be used to store any calculations made by the processing circuitry 1002 and/or any data received via the communication interface 1006. In some embodiments, the processing circuitry 1002 and the memory 1004 are integrated.

The communication interface 1006 is used in wired or wireless communication of signaling and/or data between a network node, access network, and/or UE. As illustrated, the communication interface 1006 comprises port(s)/terminal(s) 1016 to send and receive data, for example to and from a network over a wired connection. The communication interface 1006 also includes radio front-end circuitry 1018 that may be coupled to, or in certain embodiments a part of, the antenna 1010. The radio front-end circuitry 1018 comprises filters 1020 and amplifiers 1022. The radio front-end circuitry 1018 may be connected to the antenna 1010 and the processing circuitry 1002. The radio front-end circuitry 1018 may be configured to condition signals communicated between the antenna 1010 and the processing circuitry 1002. The radio front-end circuitry 1018 may receive digital data that is to be sent out to other network nodes or UEs via a wireless connection. The radio front-end circuitry 1018 may convert the digital data into a radio signal having the appropriate channel and bandwidth parameters using a combination of the filters 1020 and/or the amplifiers 1022. The radio signal may then be transmitted via the antenna 1010. Similarly, when receiving data, the antenna 1010 may collect radio signals which are then converted into digital data by the radio front-end circuitry 1018. The digital data may be passed to the processing circuitry 1002. In other embodiments, the communication interface 1006 may comprise different components and/or different combinations of components.

In certain alternative embodiments, the network node 1000 does not include separate radio front-end circuitry 1018; instead, the processing circuitry 1002 includes radio front-end circuitry and is connected to the antenna 1010. Similarly, in some embodiments, all or some of the RF transceiver circuitry 1012 is part of the communication interface 1006. In still other embodiments, the communication interface 1006 includes the one or more ports or terminals 1016, the radio front-end circuitry 1018, and the RF transceiver circuitry 1012 as part of a radio unit (not shown), and the communication interface 1006 communicates with the baseband processing circuitry 1014, which is part of a digital unit (not shown).

The antenna 1010 may include one or more antennas, or antenna arrays, configured to send and/or receive wireless signals. The antenna 1010 may be coupled to the radio front-end circuitry 1018 and may be any type of antenna capable of transmitting and receiving data and/or signals wirelessly. In certain embodiments, the antenna 1010 is separate from the network node 1000 and connectable to the network node 1000 through an interface or port.

The antenna 1010, the communication interface 1006, and/or the processing circuitry 1002 may be configured to perform any receiving operations and/or certain obtaining operations described herein as being performed by the network node 1000. Any information, data, and/or signals may be received from a UE, another network node, and/or any other network equipment. Similarly, the antenna 1010, the communication interface 1006, and/or the processing circuitry 1002 may be configured to perform any transmitting operations described herein as being performed by the network node 1000. Any information, data, and/or signals may be transmitted to a UE, another network node, and/or any other network equipment.

The power source 1008 provides power to the various components of the network node 1000 in a form suitable for the respective components (e.g., at a voltage and current level needed for each respective component). The power source 1008 may further comprise, or be coupled to, power management circuitry to supply the components of the network node 1000 with power for performing the functionality described herein. For example, the network node 1000 may be connectable to an external power source (e.g., the power grid or an electricity outlet) via input circuitry or an interface such as an electrical cable, whereby the external power source supplies power to power circuitry of the power source 1008. As a further example, the power source 1008 may comprise a source of power in the form of a battery or battery pack which is connected to, or integrated in, power circuitry. The battery may provide backup power should the external power source fail.

Embodiments of the network node 1000 may include additional components beyond those shown in FIG. 10 for providing certain aspects of the network node's functionality, including any of the functionality described herein and/or any functionality necessary to support the subject matter described herein. For example, the network node 1000 may include user interface equipment to allow input of information into the network node 1000 and to allow output of information from the network node 1000. This may allow a user to perform diagnostic, maintenance, repair, and other administrative functions for the network node 1000.

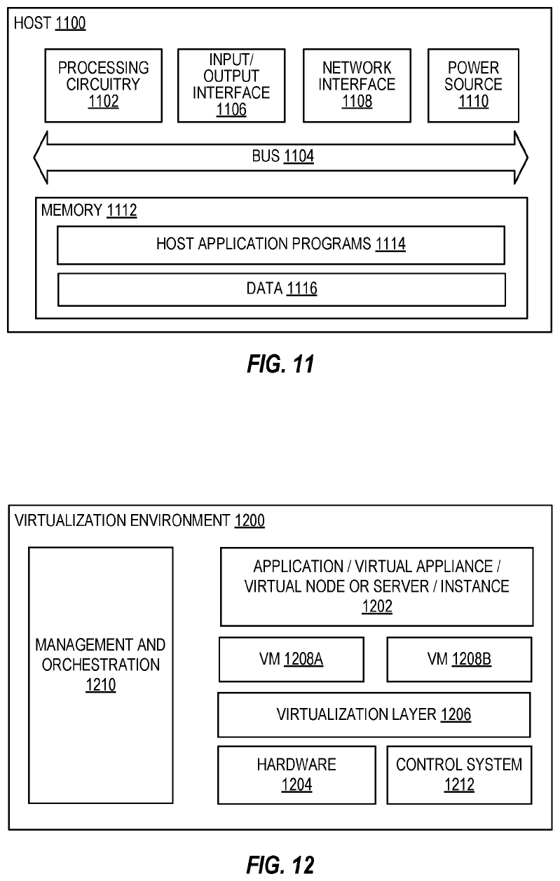

FIG. 11 is a block diagram of a host 1100, which may be an embodiment of the host 816 of FIG. 8, in accordance with various aspects described herein. As used herein, the host 1100 may be or comprise various combinations of hardware and/or software including a standalone server, a blade server, a cloud-implemented server, a distributed server, a virtual machine, container, or processing resources in a server farm. The host 1100 may provide one or more services to one or more UEs.

The host 1100 includes processing circuitry 1102 that is operatively coupled via a bus 1104 to an input/output interface 1106, a network interface 1108, a power source 1110, and memory 1112. Other components may be included in other embodiments. Features of these components may be substantially similar to those described with respect to the devices of previous figures, such as FIGS. 9 and 10, such that the descriptions thereof are generally applicable to the corresponding components of the host 1100.

The memory 1112 may include one or more computer programs including one or more host application programs 1114 and data 1116, which may include user data, e.g. data generated by a UE for the host 1100 or data generated by the host 1100 for a UE. Embodiments of the host 1100 may utilize only a subset or all of the components shown. The host application programs 1114 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 1114 may also provide for user authentication and licensing checks and may periodically report health, routes, and content availability to a central node, such as a device in or on the edge of a core network. Accordingly, the host 1100 may select and/or indicate a different host for Over-The-Top (OTT) services for a UE. The host application programs 1114 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 12 is a block diagram illustrating a virtualization environment 1200 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1202 (which may alternatively be called software instances, virtual appliances, network functions, virtual nodes, virtual network functions, etc.) are run in the virtualization environment 1100 to implement some of the features, functions, and/or benefits of some of the embodiments disclosed herein.

Hardware 1204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1206 (also referred to as hypervisors or VM Monitors (VMMs)), provide VMs 1208A and 1208B (one or more of which may be generally referred to as VMs 1208), and/or perform any of the functions, features, and/or benefits described in relation with some embodiments described herein. The virtualization layer 1206 may present a virtual operating platform that appears like networking hardware to the VMs 1208.

The VMs 1208 comprise virtual processing, virtual memory, virtual networking, or interface and virtual storage, and may be run by a corresponding virtualization layer 1206. Different embodiments of the instance of a virtual appliance 1202 may be implemented on one or more of the VMs 1208, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1208 may be a software implementation of a physical machine that runs programs as if they were executing on a physical, non-virtualized machine. Each of the VMs 1208, and that part of the hardware 1204 that executes that VM, be it hardware dedicated to that VM and/or hardware shared by that VM with others of the VMs 1208, forms separate virtual network elements. Still in the context of NFV, a virtual network function is responsible for handling specific network functions that run in one or more VMs 1208 on top of the hardware 1204 and corresponds to the application 1202.

The hardware 1204 may be implemented in a standalone network node with generic or specific components. The hardware 1204 may implement some functions via virtualization. Alternatively, the hardware 1204 may be part of a larger cluster of hardware (e.g., such as in a data center or CPE) where many hardware nodes work together and are managed via management and orchestration 1210, which, among others, oversees lifecycle management of the applications 1202. In some embodiments, the hardware 1204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1212 which may alternatively be used for communication between hardware nodes and radio units.

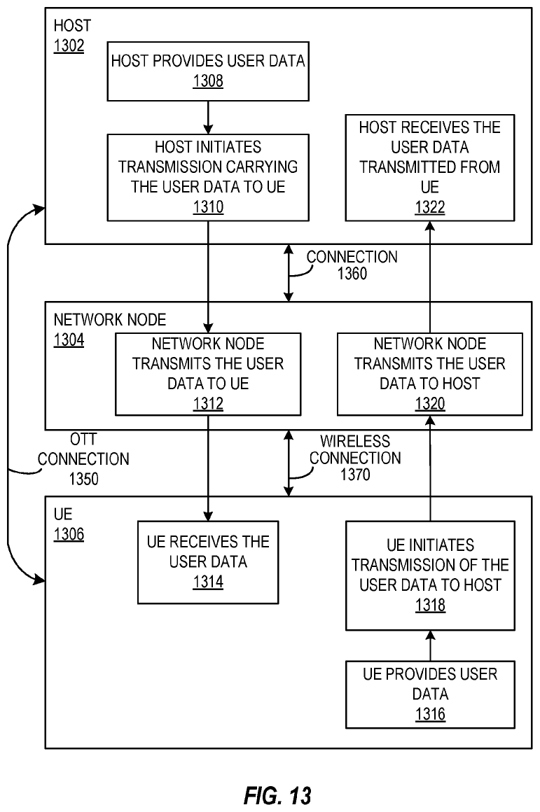

FIG. 13 shows a communication diagram of a host 1302 communicating via a network node 1304 with a UE 1306 over a partially wireless connection in accordance with some embodiments. Example implementations, in accordance with various embodiments, of the UE (such as the UE 812A of FIG. 8 and/or the UE 900 of FIG. 9), the network node (such as the network node 810A of FIG. 8 and/or the network node 1000 of FIG. 10), and the host (such as the host 816 of FIG. 8 and/or the host 1100 of FIG. 11) discussed in the preceding paragraphs will now be described with reference to FIG. 13.

Like the host 1100, embodiments of the host 1302 include hardware, such as a communication interface, processing circuitry, and memory. The host 1302 also includes software, which is stored in or is accessible by the host 1302 and executable by the processing circuitry. The software includes a host application that may be operable to provide a service to a remote user, such as the UE 1306 connecting via an OTT connection 1350 extending between the UE 1306 and the host 1302. In providing the service to the remote user, a host application may provide user data which is transmitted using the OTT connection 1350.

The network node 1304 includes hardware enabling it to communicate with the host 1302 and the UE 1306 via a connection 1360. The connection 1360 may be direct or pass through a core network (like the core network 806 of FIG. 8) and/or one or more other intermediate networks, such as one or more public, private, or hosted networks. For example, an intermediate network may be a backbone network or the Internet.

The UE 1306 includes hardware and software, which is stored in or accessible by the UE 1306 and executable by the UE's processing circuitry. The software includes a client application, such as a web browser or operator-specific “app” that may be operable to provide a service to a human or non-human user via the UE 1306 with the support of the host 1302. In the host 1302, an executing host application may communicate with the executing client application via the OTT connection 1350 terminating at the UE 1306 and the host 1302. In providing the service to the user, the UE's client application may receive request data from the host's host application and provide user data in response to the request data. The OTT connection 1350 may transfer both the request data and the user data. The UE's client application may interact with the user to generate the user data that it provides to the host application through the OTT connection 1350.

The OTT connection 1350 may extend via the connection 1360 between the host 1302 and the network node 1304 and via a wireless connection 1370 between the network node 1304 and the UE 1306 to provide the connection between the host 1302 and the UE 1306. The connection 1360 and the wireless connection 1370, over which the OTT connection 1350 may be provided, have been drawn abstractly to illustrate the communication between the host 1302 and the UE 1306 via the network node 1304, without explicit reference to any intermediary devices and the precise routing of messages via these devices.

As an example of transmitting data via the OTT connection 1350, in step 1308, the host 1302 provides user data, which may be performed by executing a host application. In some embodiments, the user data is associated with a particular human user interacting with the UE 1306. In other embodiments, the user data is associated with a UE 1306 that shares data with the host 1302 without explicit human interaction. In step 1310, the host 1302 initiates a transmission carrying the user data towards the UE 1306. The host 1302 may initiate the transmission responsive to a request transmitted by the UE 1306. The request may be caused by human interaction with the UE 1306 or by operation of the client application executing on the UE 1306. The transmission may pass via the network node 1304 in accordance with the teachings of the embodiments described throughout this disclosure. Accordingly, in step 1312, the network node 1304 transmits to the UE 1306 the user data that was carried in the transmission that the host 1302 initiated, in accordance with the teachings of the embodiments described throughout this disclosure. In step 1314, the UE 1306 receives the user data carried in the transmission, which may be performed by a client application executed on the UE 1306 associated with the host application executed by the host 1302.

In some examples, the UE 1306 executes a client application which provides user data to the host 1302. The user data may be provided in reaction or response to the data received from the host 1302. Accordingly, in step 1316, the UE 1306 may provide user data, which may be performed by executing the client application. In providing the user data, the client application may further consider user input received from the user via an input/output interface of the UE 1306. Regardless of the specific manner in which the user data was provided, the UE 1306 initiates, in step 1318, transmission of the user data towards the host 1302 via the network node 1304. In step 1320, in accordance with the teachings of the embodiments described throughout this disclosure, the network node 1304 receives user data from the UE 1306 and initiates transmission of the received user data towards the host 1302. In step 1322, the host 1302 receives the user data carried in the transmission initiated by the UE 1306.

One or more of the various embodiments improve the performance of OTT services provided to the UE 1306 using the OTT connection 1350, in which the wireless connection 1370 forms the last segment. More precisely, the teachings of these embodiments may improve power consumption, etc. and thereby provide benefits such as extended battery lifetime.

In an example scenario, factory status information may be collected and analyzed by the host 1302. As another example, the host 1302 may process audio and video data which may have been retrieved from a UE for use in creating maps. As another example, the host 1302 may collect and analyze real-time data to assist in controlling vehicle congestion (e.g., controlling traffic lights). As another example, the host 1302 may store surveillance video uploaded by a UE. As another example, the host 1302 may store or control access to media content such as video, audio, VR, or AR which it can broadcast, multicast, or unicast to UEs. As other examples, the host 1302 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1350 between the host 1302 and the UE 1306 in response to variations in the measurement results. The measurement procedure and/or the network functionality for reconfiguring the OTT connection 1350 may be implemented in software and hardware of the host 1302 and/or the UE 1306. In some embodiments, sensors (not shown) may be deployed in or in association with other devices through which the OTT connection 1350 passes; the sensors may participate in the measurement procedure by supplying values of the monitored quantities exemplified above, or by supplying values of other physical quantities from which software may compute or estimate the monitored quantities. The reconfiguring of the OTT connection 1350 may include message format, retransmission settings, preferred routing, etc.; the reconfiguring need not directly alter the operation of the network node 1304. Such procedures and functionalities may be known and practiced in the art. In certain embodiments, measurements may involve proprietary UE signaling that facilitates measurements of throughput, propagation times, latency, and the like by the host 1302. The measurements may be implemented in that software causes messages to be transmitted, in particular empty or ‘dummy’ messages, using the OTT connection 1350 while monitoring propagation times, errors, etc.

Although the computing devices described herein (e.g, LEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

Some example embodiments of the present disclosure are as follows:

### GROUP A EMBODIMENTS

Embodiment 1: A method performed by a User Equipment, UE, the method comprising: monitoring (708) a Wake-Up Signal, WUS, occasion at a start of a Wake-Up Receiver, WUR, cycle for two or more WUSs that correspond to two or more codes, respectively, that form a Wake-Up Group Identifier, WUGI, assigned to the UE; and performing (710) one or more actions based on a result of the monitoring (708).

Embodiment 2: The method of embodiment 1 wherein performing (710) the one or more actions comprises waking (710A) a main receiver of the UE if the WUGI is detected via the monitoring (708) and otherwise refraining (710B) from waking the main receiver.

Embodiment 3: The method of embodiment 1 or 2 wherein the two or more codes are two or more codes from a predefined set of orthogonal codes.

Embodiment 4: The method of embodiment 1 or 2 wherein the two or more codes are two or more codes from a predefined set of codes having sufficient auto-correlation properties to be distinguishable to UEs.

Embodiment 5: The method of embodiment 3 or 4 wherein the predefined set of codes comprises 2^{w} codes where w is number of bits that can be encoded in a WUS transmission.

Embodiment 6: The method of embodiment 5 wherein the WUGI consists of g bits wherein g>w.

Embodiment 7: The method of embodiment 6 wherein the two or more codes consist of

$$M = ⌈ \frac{g}{w} ⌉ codes .$$

Embodiment 8: The method of any of embodiments 1 to 7 further comprising receiving (704), from a network node, information that assigns the WUGI to the UE (e.g., before the UE enters a sleep mode and starts monitoring WUS occasions).

Embodiment 9: The method of any of embodiments 1 to 7 wherein the WUGI is derived (e.g., by the UE) based on a UE identity of the UE.

Embodiment 10: The method of any of embodiments 1 to 9 wherein the two or more WUSs are consecutive WUSs in the WUS occasion.

Embodiment 11: The method of any of embodiments 1 to 9 wherein bits of the WUGI are distributed over the two or more WUSs in accordance with one or more predefined or configured rules.

Embodiment 12: The method of embodiment 11 wherein w is the number of bits that can be encoded in a WUS transmission, g is the number of bits in the WUGI, the two or more WUSs consist of

$$M = ⌈ \frac{g}{w} ⌉ bits ,$$

and Mw−g paddings bits are appended to a binary representation of the WUGI.

Embodiment 13: The method of any of embodiments 1 to 12 wherein monitoring (708) the WUS occasion at the start of the WUR cycle for the two or more WUSs that correspond to the two or more codes, respectively, that form the WUGI assigned to the UE comprises monitoring for all of the two or more WUSs in the WUS occasion.

Embodiment 14: The method of any of embodiments 1 to 12 wherein monitoring (708) the WUS occasion at the start of the WUR cycle for the two or more WUSs that correspond to the two or more codes, respectively, that form the WUGI assigned to the UE comprises ceasing to monitor the WUS occasion upon determining that a WUGI transmitted does not match the WUGI assigned to the UE.

Embodiment 15: The method of any of embodiments 1 to 14 wherein the WUS occasion comprises WUSs that address only one WUGI.

Embodiment 16: The method of any of embodiments 1 to 14 wherein the WUS occasion comprises WUSs that address two or more WUGIs.

Embodiment 17: The method of any of embodiments 1 to 16 wherein the WUGI assigned to the UE is uniquely assigned to the UE.

Embodiment 18: The method of any of embodiments 1 to 16 wherein the WUGI assigned to the UE is assigned to a group of UEs, and the group of UEs comprises two or more UEs.

Embodiment 19: The method of any of embodiments 1 to 18 wherein the WUGI is a 5G-S-TMSI of the UE.

Embodiment 20: The method of any of embodiments 1 to 19 wherein the two or more codes are repeated over multiple WUS transmissions.

Embodiment 21: The method of any of the previous embodiments, further comprising: providing user data; and forwarding the user data to a host via the transmission to the network node.

### GROUP B EMBODIMENTS

Embodiment 22: A method performed by a network node, the method comprising: transmitting (706) two or more Wake-Up Signals, WUSs, in a WUS occasion at a start of a Wake-Up Receiver, WUR, cycle, wherein the two or more WUSs correspond to two or more codes, respectively, that form a Wake-Up Group Identifier, WUGI, assigned to at least one User Equipment, UE.

Embodiment 23: The method of embodiment 22 wherein the two or more codes are two or more codes from a predefined set of orthogonal codes.

Embodiment 24: The method of embodiment 22 wherein the two or more codes are two or more codes from a predefined set of codes having sufficient auto-correlation properties to be distinguishable to UEs.

Embodiment 25: The method of embodiment 23 or 24 wherein the predefined set of codes comprises 2^{w} codes where w is number of bits that can be encoded in a WUS transmission.

Embodiment 26: The method of embodiment 25 wherein the WUGI consists of g bits wherein g>w.

Embodiment 27: The method of embodiment 26 wherein the two or more codes consist of

$$M = ⌈ \frac{g}{w} ⌉ codes .$$

Embodiment 28: The method of any of embodiments 22 to 27 further comprising transmitting (704), from a network node, information that assigns the WUGI to the at least one UE (e.g., before the UE enters a sleep mode and starts monitoring WUS occasions).

Embodiment 29: The method of any of embodiments 22 to 27 wherein the WUGI is derived (e.g., by the UE) based on a UE identity of the at least one UE.

Embodiment 30: The method of any of embodiments 22 to 29 wherein the two or more WUSs are in consecutive WUS occasions.

Embodiment 31: The method of any of embodiments 22 to 29 wherein bits of the WUGI are distributed over the two or more WUSs in accordance with one or more predefined or configured rules.

Embodiment 32: The method of embodiment 31 wherein w is the number of bits that can be encoded in a WUS transmission, g is the number of bits in the WUGI, the two or more WUSs consist of

$$M = ⌈ \frac{g}{w} ⌉ ,$$

and Mw−G paddings bits are appended to a binary representation of the WUGI.

Embodiment 33: The method of any of embodiments 22 to 32 wherein the WUS occasion comprises WUSs that address only one WUGI.

Embodiment 34: The method of any of embodiments 22 to 32 wherein the WUS occasion comprises WUSs that address two or more WUGIs.

Embodiment 35: The method of any of embodiments 22 to 34 wherein the at least one

UE is a single UE, and the WUGI is assigned to the single UE.

Embodiment 36: The method of any of embodiments 22 to 34 wherein the at least one UE is a group of two or more UEs, and the WUGI assigned to the group of UEs.

Embodiment 37: The method of any of embodiments 22 to 36 wherein the WUGI is a 5G-S-TMSI of the UE.

Embodiment 38: The method of any of embodiments 22 to 37 wherein the two or more codes are repeated over multiple WUS transmissions.

Embodiment 39: The method of any of the previous embodiments, further comprising: obtaining user data; and forwarding the user data to a host or a user equipment.

### GROUP C EMBODIMENTS

Embodiment 40: A user equipment comprising: processing circuitry configured to perform any of the steps of any of the Group A embodiments; and power supply circuitry configured to supply power to the processing circuitry.

Embodiment 41: A network node comprising: processing circuitry configured to perform any of the steps of any of the Group B embodiments; and power supply circuitry configured to supply power to the processing circuitry.

Embodiment 42: A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 43: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to receive the user data from the host.

Embodiment 44: The host of the previous embodiment, wherein the cellular network further includes a network node configured to communicate with the UE to transmit the user data to the UE from the host.

Embodiment 45: The host of the previous 2 embodiments, wherein: the processing circuitry of the host is configured to execute a host application, thereby providing the user data; and the host application is configured to interact with a client application executing on the UE, the client application being associated with the host application.

Embodiment 46: A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Embodiment 47: The method of the previous embodiment, further comprising: at the host, executing a host application associated with a client application executing on the UE to receive the user data from the UE.

Embodiment 48: The method of the previous embodiment, further comprising: at the host, transmitting input data to the client application executing on the UE, the input data being provided by executing the host application, wherein the user data is provided by the client application in response to the input data from the host application.

Embodiment 49: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.

Embodiment 50: The host of the previous embodiment, wherein the cellular network further includes a network node configured to communicate with the UE to transmit the user data from the UE to the host.

Embodiment 51: The host of the previous 2 embodiments, wherein: the processing circuitry of the host is configured to execute a host application, thereby providing the user data; and the host application is configured to interact with a client application executing on the UE, the client application being associated with the host application.

Embodiment 52: A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.

Embodiment 53: The method of the previous embodiment, further comprising: at the host, executing a host application associated with a client application executing on the UE to receive the user data from the UE.

Embodiment 54: The method of the previous embodiment, further comprising: at the host, transmitting input data to the client application executing on the UE, the input data being provided by executing the host application, wherein the user data is provided by the client application in response to the input data from the host application.

Embodiment 55: A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

Embodiment 56: The host of the previous embodiment, wherein: the processing circuitry of the host is configured to execute a host application that provides the user data; and the UE comprises processing circuitry configured to execute a client application associated with the host application to receive the transmission of user data from the host.

Embodiment 57: A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.

Embodiment 58: The method of the previous embodiment, further comprising, at the network node, transmitting the user data provided by the host for the UE.

Embodiment 59: The method of any of the previous 2 embodiments, wherein the user data is provided at the host by executing a host application that interacts with a client application executing on the UE, the client application being associated with the host application.

Embodiment 60: A communication system configured to provide an over-the-top service, the communication system comprising a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

Embodiment 61: The communication system of the previous embodiment, further comprising: the network node; and/or the user equipment.

Embodiment 62: A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

Embodiment 63: The host of the previous 2 embodiments, wherein: the processing circuitry of the host is configured to execute a host application, thereby providing the user data; and the host application is configured to interact with a client application executing on the UE, the client application being associated with the host application.

Embodiment 64: The host of the any of the previous 2 embodiments, wherein the initiating receipt of the user data comprises requesting the user data.

Embodiment 65: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.

Embodiment 66: The method of the previous embodiment, further comprising at the network node, transmitting the received user data to the host.

Those skilled in the art will recognize improvements and modifications to the embodiments of the present disclosure. All such improvements and modifications are considered within the scope of the concepts disclosed herein.

1. A method performed by a User Equipment (UE) the method comprising:
monitoring a Wake-Up Signal (WUS) occasion for two or more WUSs that correspond to two or more codes, respectively, that together represent a Wake-Up Group Identifier (WUGI) assigned to the UE; and
performing one or more actions based on a result of the monitoring.

2. The method of claim 1, wherein performing the one or more actions comprises waking a main receiver of the UE if the WUGI is detected via the monitoring and otherwise refraining from waking the main receiver.

3. The method of claim 1, wherein each of the two or more codes is a code from a predefined set of orthogonal codes.

4. The method of claim 1, wherein each of the two or more codes is a code from a predefined set of codes having sufficient auto-correlation properties to be distinguishable to UEs.

5. The method of claim 3, wherein the predefined set of codes comprises 2^{w} codes where w is number of bits that can be encoded in a WUS transmission.

6. The method of claim 5, wherein the WUGI consists of g bits wherein g>w.

7. The method of claim 6, wherein the two or more codes consist of
$$M = ⌈ \frac{g}{w} ⌉ codes .$$

8. The method of claim 3, wherein:
each code from the predefined set of codes represents a different set of values for w bits; and
the sets of values for the w bits represented by the two or more WUSs for the WUGI assigned to the UE.

9. The method of claim 1, further comprising receiving, from a network node, information that assigns the WUGI to the UE.

10. The method of claim 1, wherein the WUGI is derived by the UE based on a UE identity of the UE.

11. The method of claim 1, wherein the WUGI is derived by the UE based on bits of a UE identity of the UE that are not already used for determining a paging frame or paging occasion.

12. The method of claim 1, wherein the two or more WUSs are consecutive WUSs in the WUS occasion.

13. The method of claim 1, wherein bits of the WUGI are distributed over the two or more WUSs in accordance with one or more predefined or configured rules.

14. The method of claim 13, wherein w is the number of bits that can be encoded in a WUS transmission, g is the number of bits in the WUGI, the two or more WUSs consist of
$$M = ⌈ \frac{g}{w} ⌉ bits ,$$
and Mw−g paddings bits are appended to a binary representation of the WUGI that is represented by the two or more WUSs.

15. The method of claim 1, wherein monitoring the WUS occasion for the two or more WUSs that correspond to the two or more codes, respectively, that together form the WUGI assigned to the UE comprises monitoring for all of the two or more WUSs in the WUS occasion.

16.-24. (canceled)

25. A User Equipment (UE) comprising:
a communication interface comprising a main receiver and a wake-up receiver; and
processing circuitry associated with the communication interface, the processing circuitry configured to cause the UE to:
monitor a Wake-Up Signal (WUS) occasion for two or more WUSs that correspond to two or more codes, respectively, that together represent a Wake-Up Group Identifier (WUGI) assigned to the UE;
perform one or more actions based on a result of the monitoring.

26.-49. (canceled)
